(19) United States
(12) Patent Application Publication
(10) Pub. No.: US 2023/0219607 A1
(43) Pub. Date: Jul. 13, 2023

(54) Outdoor Discovery Cart

(71) Applicant: Reflo, Inc., Milwaukee, WI (US)

(72) Inventors: Justin Hegarty, Milawaukee, WI (US); Lisa Neeb, Milwaukee, WI (US); Kevin Ristow, Milwaukee, WI (US)

(21) Appl. No.: 17/685,959

(22) Filed: Mar. 3, 2022

Related U.S. Application Data
(60) Provisional application No. 63/156,512, filed on Mar. 4, 2021.

(51) Int. Cl. B62B 3/00; B62B 5/00

(52) U.S. Cl. CPC B62B 3/005; B62B 3/004; B62B 5/0003

(57) ABSTRACT

An outdoor discovery cart is described. The outdoor discovery cart includes a frame, a plurality of wheels to support the frame, at least one shelf, and at least one door. Additionally, the outdoor discovery cart may include various storage containers or totes that can be supported by the frame and shelves. The cart allows various educational materials to easily be transported from one location to another, for instance, outdoors where traditional educational materials are not typically available. The cart may have additional features, such as locks to secure the doors and/or other components in place until a key is utilized. The various components of the cart may be made of different materials to help mimic a classroom, such as a white board, a chalk board, or metallic surfaces to enable use of magnets. The cart is full customizable based on a user's preference.

### CROSS-REFERENCE(S) TO RELATED APPLICATION(S)

This present application claims priority on U.S. Provisional Patent Application Ser. No. 63/156,512, filed on Mar. 4, 2021 and entitled Outdoor Discovery Cart, the entire contents of which are hereby expressly incorporated by reference into the present application.

### BACKGROUND OF THE INVENTION

### 1. Field of the Invention

The present invention relates in general to the field of carts used to transfer materials from one location to another. More particularly, the invention relates to an outdoor cart that supports outdoor maintenance and curricular activities. For instance, the inventive cart may include various features within the cart that allow an educational course or class to be taught outdoors. The inventive cart may be a mobile cart for interior and exterior use with various storage containers and associated locks, as well as lids such as wind-resistant lids, chalkboard and/or whiteboard faces, magnetic faces, and dimensions that support mobility and usability as a podium or standing desk.

### 2. Discussion of the Related Art

Although many traditional classes occur indoors in classrooms, outdoor classes are growing in popularity. Outdoor classrooms can provide students with the opportunity to explore lessons associated specifically with outdoor locations and conditions, such as weather, agricultural, physical activities, and the like. Furthermore, lessons typically reserved for indoor classrooms can also be taught outdoors. This can have a number of beneficial impacts on the students, including for instance allowing the students to enjoy favorable weather and providing students with an alternative learning environment to change things up. Furthermore, in light of concerns associated with the spread of infection, lessons that can be taught in a socially-distanced, outdoor setting can enable students to have an alternative to traditional indoor lessons or remote learning. Previously, teachers or other instructors would need to carry each piece of equipment that they would need for an outdoor lesson by hand Oftentimes, this meant that the full potential of outdoor lessons was not achieved.

What is needed therefore is a cart that can be used to transport various materials associated with various lesson plans to an outdoor learning space. What is further needed is a cart that includes a variety of different materials that are designed for specific lesson plans. What is further needed is a cart that also includes materials to maintain the outdoor learning space or other school grounds. While the following description will be primarily directed to use of the cart with schools, it could similarly be used by other organizations, including but not limited to ecology centers, parks and recreational groups, and any other users who would benefit from outdoor activities.

### SUMMARY AND OBJECTS OF THE INVENTION

By way of summary, the present invention is directed to an outdoor cart containing various learning materials that can be transported from location to location. The cart may be used to transport educational, outdoor, and any other materials. In addition to transporting these materials, the cart can be used to help facilitated educational lessons, for instance, writing materials on a chalk or white board.

In accordance with an aspect of the invention, the cart includes a frame, a plurality of wheel supporting the frame, and at least one shelf extending about the frame. Further, the cart may include at least one storage container that is removably insertable onto the at least one shelf Further still, the cart may have at least one door that is pivotable relative to the frame. For instance, the door may be a side door that is pivotable outwardly relative to the frame to access an interior of the frame. Additionally, the door may be a top door that is pivotable upwardly relative to the frame to access a top of the frame. The at least one door may be made of a whiteboard material, a chalkboard material, a metallic material, or any other material.

In accordance with another aspect of the invention, a method of using an outdoor discovery cart is provided. The method may include the steps of loading educational materials onto the cart, and then pushing the cart from a first location to a second location. The method may also include the step of loading educational materials onto a shelf extending between a frame of the cart. The method may further include the steps of loading educational materials into a container, inserting the container onto a shelf extending between a frame of the cart, pushing the cart, and removing the container. The method may also include the step of opening a door associated with the cart. Furthermore, the method may include the step of writing on the at least one door. The method may also include the step of closing the at least one door, after which the at least one door is locked. Additionally, the method may include the step of securing materials to the cart.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views of the inventive outdoor discovery cart, and in which:

FIG. 1 is a perspective view of an inventive outdoor discovery cart in a first position;

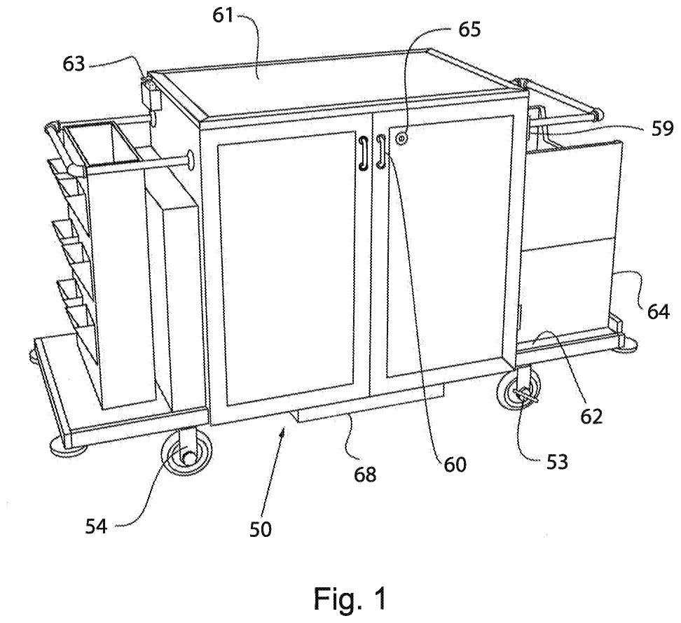

FIG. 2 is a perspective view of the inventive outdoor discovery cart in a second position in which various doors are moved to opened position;

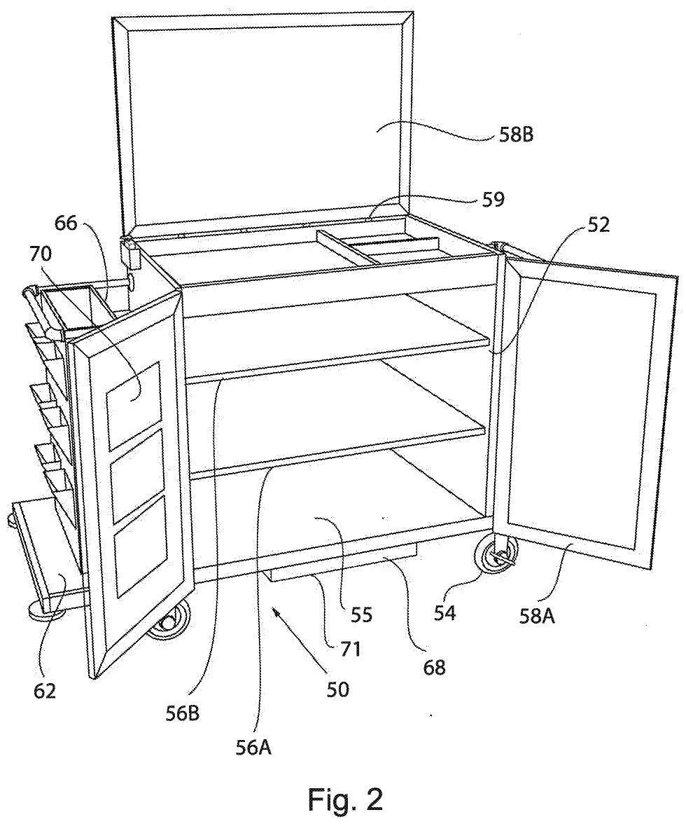

FIG. 3 is a perspective view o the inventive outdoor discovery cart having a plurality of storage containers removably contained therein.

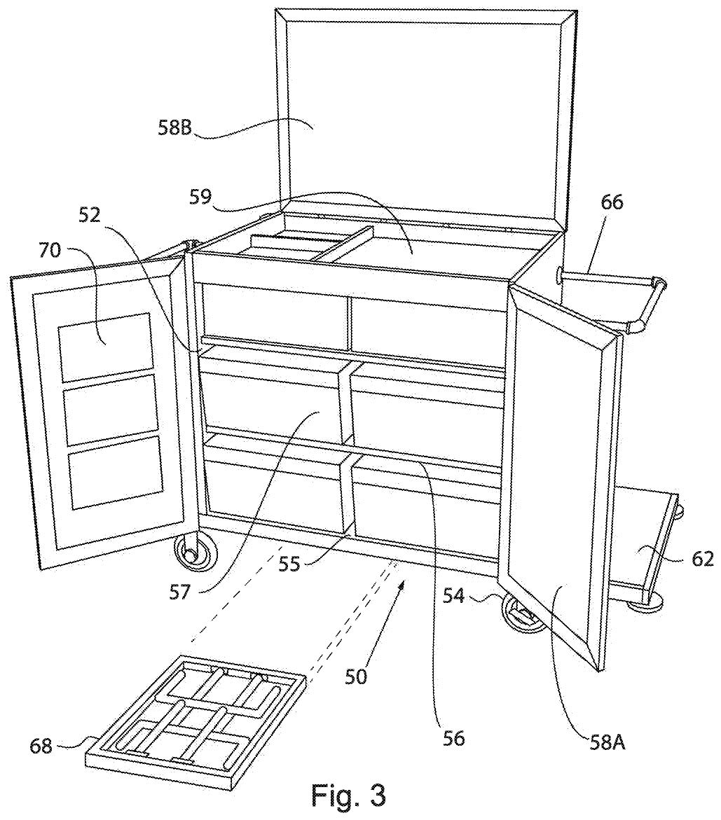

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

1. System Overview

The invention is a mobile discovery cart that is configured to be moved from location to location to deliver various materials, for instance, outdoor maintenance and curricular materials. The cart may have a number of different features, including a mobile cart configured for interior or exterior use, variable lockable features, supply storage, wind-resistant white board lids with storage compartments, chalkboard face, and magnetic faces, as well as dimensions that support mobility and usability as a podium or a standing desk. The cart is configured to support educators as they teach outdoors and maintain the outdoor area. The cart is similarly configured for use outside of school environments, for instance, at ecology centers, park and recreational centers, and anywhere else where outdoor programming could occur.

2. Detailed Description of Preferred Embodiments

Referring now to the figures, a mobile cart 50 is shown that can be transported from location to location to provide various materials to educators and other individuals. The cart 50 includes a frame 52 supported by a plurality of wheels 54. The wheels 54 are preferably pivotable to facilitate easy movement of the cart 50. Also, one or more of the wheels 54 may have a releasable lock 53, such that the wheels 54 can be secured in place once the cart 50 arrives at a given location. Additionally, the wheels may be of a durable material that would facilitate easy rotation on outdoor surfaces, including grass, concrete, sand, asphalt, and the like, as well as indoor surfaces such as carpet, hardwood, and other flooring. As shown, the frame 50 is substantially rectangular, although it could similarly be any other desired shape. The figures show exemplary sizes of carts 50, but of course larger or smaller carts may be desired depending on the purpose of the cart 50, the area in which it will be used, available storage space, and any other relevant factors.

The cart 50 may have a plurality of shelves 56 located therein. For instance, the cart 50 may have two shelves 56A, 56B, in addition to the bottom 55 of the cart and the top 61 of the cart 50. The cart 50 may also have at least one door 58 mounted to the frame 52 using a hinge or hinges 59 in order to conceal items contained within the frame. For instance, as shown there are side doors 58A mounted to the side of the frame 52 that are configured to pivot outwardly to allow access to an interior of the cart 50. The interior of the cart 50 includes the shelves 56 where items can be placed directly thereon. Otherwise, various storage containers 57, tubs, and the like can be removably rested on the shelves 56. These containers 57 may be in a number of sizes and shapes depending on the size of the cart 50, the size of the materials contained within the containers 57, and any other relevant factors. As also shown, there may be a top door 58B or lid that is configured to pivot upwardly to allow access to a top of the cart 50. As shown, the top of the cart has a number of additional compartments 59. As such, various materials can similarly be safely stored into the compartments. For instance, pens, pencils, crayons, chalk, markers, paper, notebooks, and the like can all be stored in the additional compartments. Also, a bottle of hand sanitizer 63 may be mounted to the cart 50, as could other cleaning materials, towels, paper towels, garbage bags, etc.

The various components of the cart 50, including by way of example the doors 58, may be made of a variety of materials. For instance, the doors 58 may be made of common sturdy materials such as wood or plastic. Alternatively, the doors 58 may be made of different materials that would enable users to mark directly on the doors 58. For instance, the doors 58 may be made of a white board, dryboard, chalkboard, or other material that allows users to write or draw directly onto the doors 58, after which the writing or drawings can be erased. Using such a material helps to enable the cart 50 to be used as a classroom, where the dryboard or chalkboard can be vertically oriented for students to easily view. Additionally, the doors 58 may be made of a metallic material, which would allow for further customization in the form of magnets.

Additionally, the door or doors 58 may be equipped with handles 60 to help facilitate opening of the doors 58. The cart 50 may also have locks to secure the contents of the cart 50. For instance, locks 65 may be installed on the doors to disable access to the interior without disengagement. Similarly, locks may be used with any of the shelves or contents secured therein.

Further, the cart 50 may have additional shelves, for instance, exterior shelves 62 extending from the front and the back of the cart 50. Additional storage compartments 64 can be mounted on or adjacent to these exterior shelves 62. For instance, storage containers 64 are shown as resting on the exterior shelve 62, while also having a top edge that is secured to the frame 52. More specifically, a mount bar 66 may be secured to the front and back of the frame 52. Various components can be mounted to the mount bar 66. Additionally, the mount bar 66 can be gripped and used as a handle when a user is pushing the cart 50 around. Further still, multiple mount bars may be mounted to the side of the cart 50. These mount bars 66 also allow various materials to be hung therefrom.

Additional features may be mounted to the cart 50. For instance, a foldable table 68 may be mounted to the side or underside of the cart 50. The foldable table 68 may be mounted directly to the frame 52, otherwise a holder 71 may be provided within which the table 68 can be inserted. Other pieces of equipment may similarly be mounted to the cart 50 in order to make it easier to transport the cart 50 from location to location without having to carry the table 68 or other materials. Additionally, various holders 70 may be mounted to the interior of the cart 50. For instance, holders 70 may be mounted to the interior of the any of the doors 58. These holders 70 may be configured to hold clipboards, magazines, books, binders, notebooks, etc. Further still, the cart 50 may have hooks, straps, or any other features that could hold or support various outdoor equipment, for instance, shovels, garden equipment, and other tools. These hooks or straps could also include locks to secure the various equipment to the cart 50. Further still, various other materials may be mounted to the cart 50, such as a calendar, a chart to be completed that summarizes various outdoor projects for completion, various student artwork, and the like.

Furthermore, the cart 50 may be customized. For instance, various logos, stickers, labels, and the like may be mounted to, or drawn, painted, engraved, or otherwise embedded with various aspects of the cart 50. Additionally, the actual materials used to create the cart 50, including for instance the doors 58, could be selected from any number of different designs, including wood routed designs.

The resulting cart 50 includes a variety of component parts to work together to provide a mobile storage and interactive cart that can be used for both formal and non-formal educators. This allows educators to easily move educational materials from one space to another efficiently while optimizing use of the outdoor space. In light of infection concerns, the cart 50 helps to allow for classes to occur outside, where spread of germs can be minimized due to the ventilation of outdoor spaces. The design is made to allow all of the component parts to work together and fit the design constraints. For instance, a balance between the amount of storage space and the mobility of the cart is desired. Stated differently, in certain contexts where the amount of storage is important, a larger cart could be used that is less mobile. In other contexts, where a small, mobile cart is desired, less storage space may be present.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the illustrations provide exemplary cart devices, and the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. An outdoor discovery cart configured to transport one of educational and outdoor materials from one location to another.

2. The outdoor discovery cart of claim 1, further comprising:
a frame;
a plurality of wheels supporting the frame; and
at least one shelf extending about the frame.

3. The outdoor discovery cart of claim 2, further comprising at least one storage container removably insertable onto the at least one shelf

4. The outdoor discovery cart of claim 2, further comprising at least one door pivotable relative to the frame.

5. The outdoor discovery cart of claim 4, wherein the at least one door is a side door pivotable outwardly relative to the frame to access an interior of the frame.

6. The outdoor discovery cart of claim 4, wherein the at least one door is a top door pivotable upwardly relative to the frame to access a top of the frame.

7. The outdoor discovery cart of claim 4, wherein the at least one door is made of a whiteboard material.

8. The outdoor discovery cart of claim 4, wherein the at least one door is made of a chalkboard material.

9. The outdoor discovery cart of claim 4, wherein the at least one door is made of a metallic material.

10. A method of using an outdoor discovery cart comprising the steps of:
loading educational materials onto the cart; and
pushing the cart from a first location to a second location.

11. The method of claim 10, further comprising the step of loading educational materials onto a shelf extending between a frame of the cart.

12. The method of claim 10, further comprising the steps of:
loading educational materials into a container;
inserting the container onto a shelf extending between a frame of the cart;
pushing the cart; and
removing the container.

13. The method of claim 10, further comprising the step of opening at least one door associated with the cart.

14. The method of claim 13, further comprising the step of writing on the at least one door.

15. The method of claim 13, further comprising the steps of:
closing the at least one door; and
locking the at least one door.

16. The method of claim 10, further comprising the step of securing materials to the cart.

17. An outdoor discovery cart comprising:
a frame;
a plurality of shelves mounted to the frame;
a plurality of storage containers supported by the plurality of shelves;
at least one door pivotably rotatable relative to the frame;
wherein the outdoor discovery cart is configured to transport educational and outdoor materials from one location to another.

18. The outdoor discovery cart of claim 17, further comprising a plurality of holders mounted to the at least one door.

19. The outdoor discovery cart of claim 17, further comprising:
a holder mounted to a bottom of the frame; and
a foldable table releasably insertable into the holder.

20. The outdoor discovery cart of claim 17, further comprising at least one lock configured to releasably hold the at least one door in place. a frame;
a plurality of wheels supporting the frame; and
at least one shelf extending about the frame.
